(19) United States
(12) Patent Application Publication
(10) Pub. No.: US 2021/0178886 A1
(43) Pub. Date: Jun. 17, 2021

(54) Dual Mode Power Split Powertrain for Hybrid Electric Vehicles

(71) Applicants: DHAVAL BHIKHUBHAI LODAYA, LISLE, IL (US); POUYAN AHMADIZADEH, TEHRAN (IR)

(72) Inventors: DHAVAL BHIKHUBHAI LODAYA, LISLE, IL (US); POUYAN AHMADIZADEH, TEHRAN (IR)

(21) Appl. No.: 16/718,160

(22) Filed: Dec. 17, 2019

(51) Int. Cl. B60K 6/365; F16H 3/64; B60W 20/30; B60K 6/54

(52) U.S. Cl. CPC B60K 6/365; F16H 3/64; B60K 6/24; B60K 6/54; B60W 20/30

(57) ABSTRACT

In recent years, electrification of powertrain has become mainstream to meet regulatory fuel economy and emissions. The present invention of dual mode power-split transmission relates generally to hybrid electric drive systems and its configuration. The designed transmission is capable of operating in two modes, input split and compound split mode thereby providing three mechanical points and an ability to maintain high transmission efficiency and continuous power output throughout the speed range. This is due to specific arrangement of power sources, clutches and designed gear ratios of the planetary gears. The dual mode power-split transmission also makes it possible to downsize the electric machines.

### FIELD OF THE INVENTION

The present invention relates generally to hybrid electric drive systems and its configuration. More specifically, the present invention is a dual mode power split transmission.

### BACKGROUND OF THE INVENTION

The growing need for improving fuel economy and reducing emissions in the transportation sector has led to development of many advanced electric drive technologies in powertrain system of the vehicle. Conventionally, such vehicles included a single power source, i.e. internal combustion engine, coupled to wheels via transmission system. Even though such systems are capable of meeting the tractive load demand, they have an inherent limitation that the engine must be sized to meet entire bandwidth of load demand and hence must accelerate and decelerate between transmission ratios. This generally results in Engine not being able to operate within its most efficient operating region. Moreover, since Engine is sized for entire bandwidth of load demand, it is over sized for majority of its operating periods, which is analogous to city driving. This leads to inefficient use of fuel and thereby resulting in poor fuel economy and higher emissions.

As a solution to this problem, hybrid powertrain started gaining traction. Today, HEVs are classified into three main categories based on the powertrain architecture they introduce: Series, Parallel and Power-split Hybrid. Series hybrid is the simplest one, wherein the engine acts as a power source, coupled to a generator that provides a resistive torque to the engine. As the engine turns the generator, mechanical energy is converted into electrical energy which is then stored in a battery or used to drive one or more electrical motors directly. The electrical energy from battery is used to drive one or more electrical motors which propels the vehicle. In this configuration, engine is not rigidly connected to the vehicle and hence can operate at its efficient operating region, thus leading to lower fuel consumption as compared to conventional vehicles.

While the series hybrid is more fuel efficient as compared to conventional vehicles, it has several drawbacks. For instance, the number of energy conversions increases; namely, the fuel energy which is stored in chemical form is converted to mechanical energy in engine, which is then converted to electrical form by generator and stored in battery, this electrical energy is again converted into mechanical energy by electric motors to propel the vehicle. These multiple energy conversion increases overall inefficiency of the system especially during the highway driving conditions. Moreover, since electric motors must supply all the torque to propel the vehicle, it should be sized to meet all the anticipated load demands. This increases weight and cost of the machine and leads to decrease in the overall efficiency.

As a solution to the problems encountered by conventional and series hybrid powertrains, parallel hybrid transmission was introduced. As the name suggests, parallel hybrid involves the ability for the powertrain to drive via multiple power sources. One power source could also act as an assist of power for another power source or can drive the vehicle independently. Depending on placement of engine and electric motor in the driveline, different parallel hybrid powertrain configurations are possible. P0 hybrid, which is usually regarded as a mild hybrid involves electric motor acting as a Belted Starter Generator (BSG), connected to the accessory drive. P1 hybrid, where electric machine is directly connected to the crankshaft of the internal combustion engine. P2 hybrid, where electric machine is connected to the input shaft of the transmission and there is a clutch between engine and electric machine to decouple the two power sources. P3 hybrid, where electric machine is connected to the output shaft of the transmission, is decoupled from the engine and its speed is a multiple of wheel speed. P4 hybrid, where electric machine is connected to the rear axle of the vehicle, thus acting as an independent e-axle drive. Various combinations of these parallel configurations are also possible, like P0/P4 hybrid. Based on the configuration of parallel hybrid, multiple operating modes such as torque boosting, load shifting, regenerative braking, electric-drive and so on are possible.

Of particular interest for present application is power-split devices (PSD) which has the possibility of different kinds of configurations, which is provided by flexibility in the number of planetary gears, number and position of clutches and the way the power sources are connected to the gears. This configuration offers benefits of both series and parallel architecture in terms of different operating modes and savings in fuel consumption.

### SUMMARY OF THE INVENTION

The designed dual mode power-split powertrain consists of two planetary gears, two clutches, two electric machines and an internal combustion engine. Motor/Generator 1 and 2 are connected to the sun gear and ring gear of the simple planetary gearset. Engine is connected to the planet carrier of the simple planetary gearset.

Second planetary gearset is a compound gearset, that has four gears, namely, front sun gear, rear sun gear, ring gear and planetary carrier. The rear sun is connected to the ring gear of simple planetary gearset and the carrier is connected to the vehicle output for propelling the vehicle. The connection of its two other gears is dependent on the performance and operation of clutch 2 and clutch 1. Clutch 1 engages or disengages to connect or disconnect the front sun of compound planetary gearset to the sun gear of the simple planetary gearset. Clutch 2 is engaged or disengaged to lock or unlock the ring gear of compound gearset to the ground.

Thus, two modes can be provided depending on the performance of the two clutches. In the mode 1, which is an input split mode, clutch 1 is released and clutch 2 is locked to the ground. In mode 2, which is a compound split mode, clutch 1 is locked which makes front sun and sun gear to rotate with the same speed and clutch 2 is released to ring gear of compound gearset to rotate freely.

Other features such as power flow and advantages from the disclosed principle will be discerned from the following description, taken in coherence with the drawings.

### BRIEF DESCRIPTION OF THE DRAWINGS

FIG. 1 is a simplified schematic view of the powertrain with power-flow in the Power-Split Device (PSD) of Hybrid Electric Vehicle (HEV) in accordance with the disclosed principles;

FIG. 2 is a schematic illustration of designed Dual Mode Power-split Transmission in accordance with the disclosed principles;

FIG. 3 is a schematic illustration of implemented compound planetary gearset in accordance with the disclosed principles;

FIG. 4 shows the transmission efficiency of the implemented powertrain system for both modes in terms of the speed ratio in accordance with the disclosed principles;

FIG. 5 shows the power ratio versus speed ratio of the implemented powertrain system for both modes in accordance with the disclosed principles;

FIG. 6 is an illustrative front view of the designed Dual Mode Power-split Transmission in accordance with the disclosed principles; and

FIG. 7 is an illustrative back view of the designed Dual Mode Power-split Transmission in accordance with the disclosed principles.

### DETAIL DESCRIPTIONS OF THE INVENTION

All illustrations of the drawings are for the purpose of describing selected versions of the present invention and are not intended to limit the scope of the present invention.

This disclosed principle relates primarily to dual mode power-split transmission with two modes, input split mode and compound split mode. The described principles are set forth particularly with reference to IC Engine/Electrical path variable transmission and to be used in Hybrid Electric Vehicle (HEV).

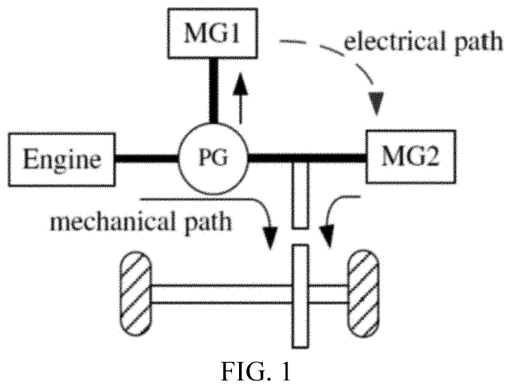

FIG. 1 is a simplified view of the powertrain with power-flow in the Power-Split Device (PSD) of HEV. This shows a general energy flow in terms of mechanical and electrical paths in a vehicle. Here, the engine torque is split in two paths, viz. mechanical and electrical at the input gear of a planetary gearset and then the split power flows to the output without any further split ratio. Electrical path is due to Motor/Generator 1 (MG1) which acts as a generator thereby absorbing Engines Power and converting mechanical power to electrical which is stored in the battery. This stored electrical power in the battery can then be used by Motor/Generator 2 (MG2) which acts as a Motor while propelling the vehicle and acts as a generator thereby absorbing torque while exhibiting regenerative braking, thereby flow of current reverses its direction from MG2 to the battery. This mode is called as input split mode. The particular details of the transmission will be explained in detail in conjunction with other figures.

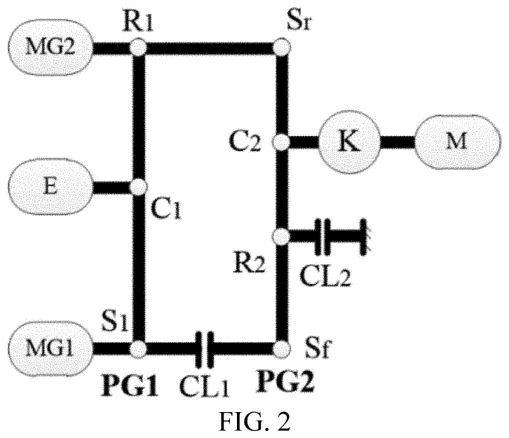

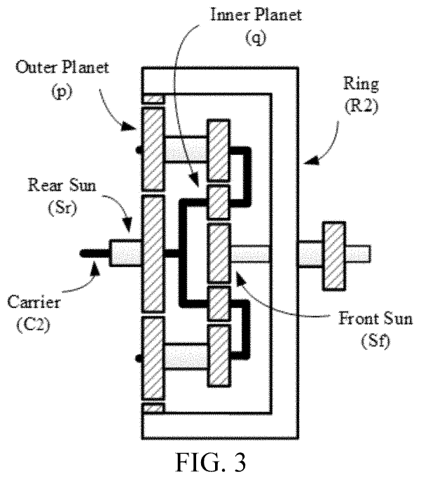

FIG. 2 and FIG. 3 demonstrates the overall layout of the designed dual mode power-split powertrain. It consists of two electric machines (MG1 and MG2), two clutches (CL1 and CL2), and the engine. MG1 and MG2 are connected to the sun and ring gear where-as the engine is connected to the planetary carrier of the simple planetary gear set (PG1). The compound planetary gearset (PG2) has four gears. The rear sun (Sᵣ) is connected to the ring gear of PG1 and the carrier is connected to the vehicle output. Connections of its two other gears is dependent on the performance of CL1 and CL2. When CL1 is engaged, Front Sun (S_{f}) is connected to the sun gear (S₁) of the simple planetary gear set and both rotate with the same speed. CL2 locks or unlocks the ring gear (R₂) of PG2 to the ground. Two modes are described, input split mode and compound split mode. Input split mode operation is discussed in conjunction with FIG. 1 above. In mode 2, which is a compound split mode, CL1 is locked which makes S₁ and S_{f} to rotate with the same speed and CL2 is released which leads to R₂ to rotate freely. The split engine torque at the input flow to the output via two different paths with experiencing another split ratio in this mode. A controller is responsible for coordinating the operation of MG1, MG2, IC Engine as well as the mode and ratio of the transmission. The advantages of using two modes will be discussed in conjunction with other figures.

In input split and compound split modes, the speed relationship between MG1, MG2 and IC Engine are related to each other according to dynamic equations that are governed by further elements such as load torques of the engine, road, MG1, MG2, radii of the gears of PG1 and PG2, Inertias of the power sources, tire radius, final drive ratio, vehicle mass, internal reaction forces between planetary gears and so on. The gear ratios obtained for the designed dual mode power-split transmission will be discussed in conjunction with other figures.

Two types of power-flow can be defined in the power-split powertrain, power splitting and power circulation. Power circulation leads to no useful output work and thereby reduces the overall efficiency of the system. In the power splitting mode, there are mechanical and electrical paths. When the Engine power flows through the electrical path, it leads to reduction of the overall efficiency. Thus, the dual mode power-split transmission was designed to reduce the amount of engine power flowing through the electrical path. Based on the vehicle speed, power splitting occurs at low vehicle speed while power circulation happens at high vehicle speed for input split devices. The designed dual mode PSD has the ability to reduce the amount of power splitting and decreasing the range of speed at which power circulation occurs. The designed dual mode PSD uses the concept of Mechanical Points (MP) to obtain optimum transmission ratios. In PSDs, when engine power flows through only mechanical path, maximum efficiency is achieved. The designed dual mode power-split device is capable of providing three MPs, one for input split mode and two for compound split mode. By calculating the speed ratio of input-to-output when one of the MGs has the speed of zero, transmission ratios of MP was obtained to be: R₁=3, S₁=1, R₂=3, S_{f}=1.3, Sᵣ=2.4 and kₚ=1. MP for Mode 1 is 1.68, and MP for Mode 2 is 1.15 and 0.71. By having these MPs, powertrain system efficiency remains high at most of the driving conditions. This will be exhibited in conjunction with other figures descriptions.

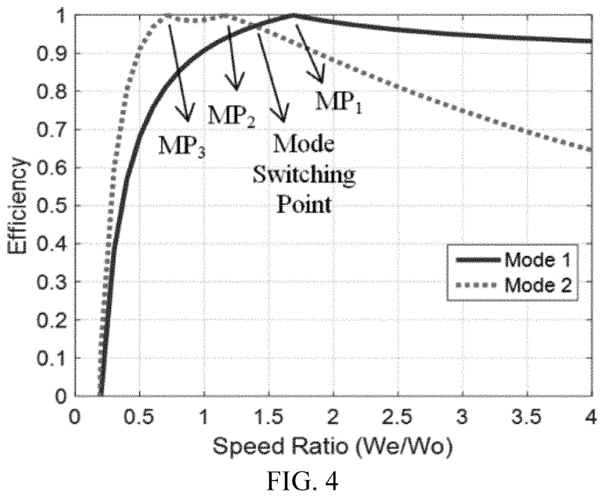

FIG. 4 shows the transmission efficiency of the dual mode PSD. Speed Ratio is the ratio of engine speed to output speed of the vehicle. The HEV starts in Mode 1 since it has higher efficiency than Mode 2 while launching. After MP1 is reached while in Mode 1, the efficiency of transmission starts to drop with increase in vehicle speed or decrease in speed ratio. The controller is responsible for switching the system to Mode 2 at this point to keep the system at higher efficiency at higher speeds. Thus, designed dual mode PSD is capable of achieving high efficiency throughout the speed ratio.

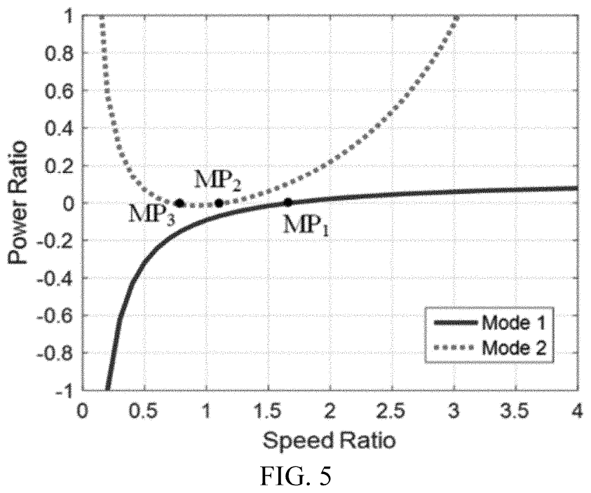

FIG. 5 shows the Power Ratio versus Speed Ratio of the designed dual mode PSD. Power Ratio is the power of electrical path to the input power from IC Engine. Power circulation occurs when Power Ratio becomes negative and this occurs with increase in vehicle speed or decrease in Speed Ratio in Mode 1. Power circulation results in lower overall system efficiency due to multiple conversions between mechanical and electrical paths. It is evident from FIG. 5 that the designed dual mode PSD has very low power circulation due to presence of Mode 2. With increase in the vehicle speed, the controller switched to Mode 2 to minimize power circulation and keep the overall system efficiency high. Presence of MP2 and MP3 enables the system to extract continuous power from electric machines in higher speeds.

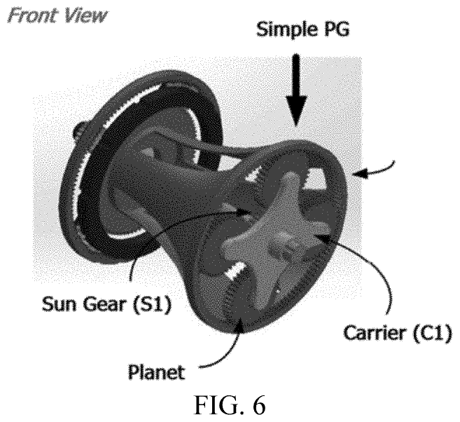

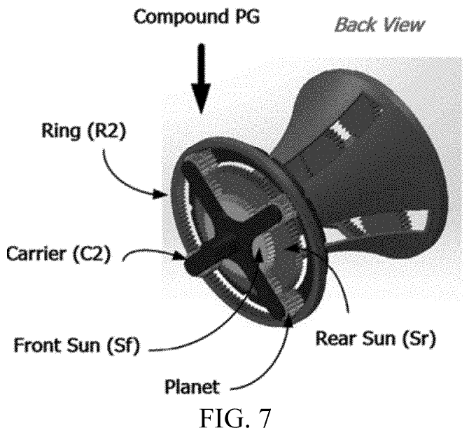

FIG. 6 and FIG. 7 shows an illustrative front and back view respectively, of the designed dual mode PSD.

The present disclosure has applicability to hybrid electric drive systems for vehicle propulsion and is applicable over a wide range of speed and torque while maintaining high system efficiency. The disclosed principles could be beneficial to many types of propelled machines/vehicles including, on and off roading vehicles, trucks, tractors, excavators and other on-highway and off-highway machines.

Foregoing description provides the examples and benefits of the disclosed system and process. Other implementations of the disclosure may differ from this and thus all the references and examples are intended to this particular discussion, thereby they are not intended to imply any sort of limitations with respect to the scope of the disclosure more generically. All technicalities and language of distinction and disparagement with respect to certain components or features that are not discussed in detail in this disclosure is due to the fact that they are previously known or are not of significant importance for the highlight of this disclosure, it is not intended to exclude them from the disclosure unless explicitly indicated.

Although the invention has been explained in relation to its preferred embodiment, it is to be understood that many other possible modifications and variations can be made without departing from the spirit and scope of the invention.

What is claimed is:

1. A dual mode power-split transmission for hybrid electric drive system to propel a vehicle or machine using a combination of power sources, drive systems comprising of:
a. A Motor/Generator 1 having an output for providing rotational power and absorbing torque during recuperation.
b. A Motor/Generator 2 having an output for providing rotational power and absorbing torque for recuperation.
c. An Internal Combustion Engine having an engine output for providing rotational power.
d. A transmission comprising of simple planetary gearset and compound planetary gearset for receiving rotational power from the Motor/Generator 1, Motor/Generator 2, and Internal Combustion Engine, and to combine rotational power into transmission output power to propel the vehicle or machine, the transmission including components:
i. A simple planetary gearset comprising of sun gear, ring gear and planetary carrier linked to Motor/Generator 1, Motor/Generator 2 and Internal Combustion Engine respectively.
ii. A compound planetary gearset comprising of front sun gear, rear sun gear, ring gear and planetary carrier connected to sun gear of simple planetary gearset via first clutch, ring gear of simple planetary gearset, ground via second clutch and vehicle output respectively.
iii. First clutch linking sun gear of simple planetary gearset with front sun gear of compound planetary gearset. Disengaging first clutch and engaging second clutch thereby grounding ring gear of compound planetary gearset results in Mode 1 or Input Split Mode. Engaging first clutch results in sun gear of simple planetary gearset and front sun of compound planetary gearset to rotate with same speed and disengaging second clutch results in ring gear of compound planetary gearset to rotate freely thereby resulting in Mode 2 or Compound Split Mode. Both modes exhibit distinct transmission characteristics.

2. The dual mode power-split transmission for hybrid electric drive system in accordance with claim 1, further comprises of a controller that is electrically linked to power sources, Motor/Generator 1, Motor/Generator 2 and Internal Combustion Engine and is programmed to control the operating mode of the transmission by selectively engaging and disengaging both clutches, thereby controlling power and speed outputs of the transmission.

3. The dual mode power-split transmission for hybrid electric drive system in accordance with claim 1, first mode or input split mode operates until Mechanical Point 1 which is determined by the gear ratios specified and relates to the speed ratio, including engine speed and output speed. The engine torque is split into two paths, electrical and mechanical at the input gear, planetary carrier of simple planetary gearset and then split power flows to the output without any further split ratio.

4. The dual mode power-split transmission for hybrid electric drive system in accordance with claim 1, second mode or compound split mode operates in Mechanical Point 2 and Mechanical Point 3, which is determined by the gear ratios specified and relates to the speed ratio, including engine speed and output speed. The split engine torque at input flows to the output via two different paths with experiencing another split ratio in this mode.

5. The dual mode power-split transmission for hybrid electric drive system in accordance with claim 1, wherein the switching between two modes is synchronous.

6. The dual mode power-split transmission for hybrid electric drive system in accordance with claim 1, wherein Mode 1 is used for lower vehicle speeds whereas Mode 2 is used for higher vehicle speeds. Mechanical Point 1 to Mechanical Point 3 ensures high system efficiency in all speed ranges and continuous power from electric machines in higher speeds.

7. The dual mode power-split transmission for hybrid electric drive system in accordance with claim 6, makes it possible to downsize electric machines.
